(19) United States
(12) Patent Application Publication
(10) Pub. No.: US 2012/0326840 A1
(43) Pub. Date: Dec. 27, 2012

(54) LOCK BOX SYSTEM FOR DEPOSITING AND RETRIEVING OBJECTS AND METHOD FOR OPERATING SUCH A LOCK BOX SYSTEM

(75) Inventors: Steffen Frankenberg, Rheinbach (DE); Martin Räss, Munchen (DE); Christian Metzner, Koln (DE); Joachim Kunz, Bonn (DE)

(73) Assignee: Deutsche Post AG, Bonn (DE)

(21) Appl. No.: 12/444,241

(22) PCT Filed: Aug. 14, 2007
(86) PCT No.: PCT/EP07/07177

§ 371 Date: Dec. 15, 2009

(30) Foreign Application Priority Data
Oct. 6, 2006 (DE) 10 2006 047 797.9

(51) Int. Cl. G05B 19/00

(52) U.S. Cl. 340/5.65

(57) ABSTRACT

There is provided a lock box system that is adapted to deposit objects into and retrieve objects from a plurality of compartments of the lock box system, each compartment having an unambiguous identifier and a door that can be locked by an associated locking device. An exemplary lock box system comprises a data processing unit that is adapted to determine which compartments contain an object, whereby dimensions of at least two of the compartments differ from each other and these dimensions of the compartments are stored in the data processing unit. The exemplary lock box system also comprises a centralized facility reading device that is connected to the data processing unit, the centralized facility reading device having a detector that is adapted to simultaneously detect a plurality of RFID transponders located within a defined area around the centralized facility reading device, the centralized facility reading device additionally comprising a data reading device that is adapted to simultaneously read out data from the plurality of RFID transponders, wherein the data read out from a particular one of the plurality of RFID transponders contains at least dimensions of an associated object. The exemplary lock box system further comprises a receiving and processing device connected to the data processing unit, the receiving and processing device being adapted to receive the data read out from the particular one of the plurality of RFID transponders, the receiving and processing device being adapted to, based on dimensions of the associated object and a query of an occupation status of the plurality of compartments, identify a free one of the plurality of compartments having dimensions sufficiently large to accommodate the associated object. The exemplary lock box system additionally comprises a transmitter that is adapted to transmit the identity of the free one of the plurality of compartments to the control unit. In addition, the exemplary lock box system comprises a control unit connected to the data processing unit, the control unit having an actuator that is adapted to actuate the locking device via control signals, the control unit being adapted to simultaneously or consecutively generate and/or transmit control signals to the locking device associated with the identified free one of the plurality of compartments to open the door of the identified free one of the plurality of compartments.

### CROSS REFERENCE TO RELATED APPLICATIONS

Pursuant to 35 U.S.C. §371, this application is the United States National Stage Application of International Patent Application No. PCT/EP2007/007177, filed on Aug. 14, 2007, the contents of which are incorporated by reference as if set forth in their entirety herein, which claims priority to German (DE) Patent Application No. 10 2006 047 797.9, filed Oct. 6, 2006, the contents of which are incorporated by reference as if set forth in their entirety herein.

### BACKGROUND

The state of the art encompasses lock box facilities that employ RFID technologies for various areas of application, for example, in order to identify objects deposited into the lock box facility or to identify users of the lock box facility. Lock box facilities can especially be used as electronic parcel deposit box facilities to which users can send objects so that they can be later retrieved from the parcel deposit box facility at a freely selectable point in time. Here, for example, objects such as parcels are provided with RFID transponders so that they can be identified in a parcel transport and parcel distribution system and so that their transport route can be tracked.

The RFID transponder on an object can also be used to acquire specific information about the object at a lock box facility. When an object is dropped off at a lock box facility by a user, the object can be held, for example, in the vicinity of a reading device by means of which data is read out from the transponder. Such data includes, for example, the owner of the object, the content or the dimensions of the object. This data does not have to be entered manually by the user at the lock box facility but rather can be read directly into a data processing unit of the lock box facility and processed there. Moreover, supplementary information can also be generated and additionally stored in the RFID transponder.

For example, Japanese patent application JP 2005263471 A discloses a lock box facility for the automated acceptance of pieces of luggage. Each piece of luggage is provided with an RFID tag that is scanned by a scanner of the lock box facility once the piece of luggage has been placed into the facility. The acquired information is displayed on a monitor of the facility and the weight of the piece of luggage as well as the fees for the storage are ascertained. The fees can be paid by means of a card and the additionally generated data is written into the RFID transponder.

Moreover, RFID transponders can be used on objects to ascertain whether an object has been deposited into a lock box facility. For example, U.S. Pat. Appln. No. 2005/0068181 A1 discloses a lock box facility in which an active or passive RFID tag is located. If several compartments are used exclusively by one user, a tag can be associated with the entire group of compartments. A clerk who deposits the objects into the lock box facility has a reading device like a wristwatch that is located, for example, on his or her wrist. As soon as the clerk deposits an object into a compartment, the tag of that particular compartment is in the vicinity of the reading device and the identification of the tag is read out by the reading device. The reading device transmits the acquired information to a central data processing unit which, on the basis of this information, can inform the recipient of the deposited object that a shipment has been deposited for him or her to pick up.

Furthermore, international patent application WO 2006/000016 A1 discloses a system for monitoring lock box facilities in which each compartment has a reading device for detecting RFID tags. Objects deposited into the lock box facility are each provided with an RFID transponder, and the removal of an object from a compartment is ascertained in that an RFID tag can no longer be detected in the vicinity of a reading device.

In particular, international patent application WO 01/52199 A2 discloses a lock box facility and a method for operating the facility, in which a user can be identified at the facility not only by entering alphanumeric characters, magnetic cards, barcodes or biometric data, but also by means of a transponder chip so that he or she can deposit or pick up a consignment.

Consequently, the use of RFID technologies in the realm of lock box facilities facilitates delivery and pick-up procedures, and it also allows a simple acquisition of data at a facility. If consignments such as letters or parcels are provided with RFID transponders within a mail shipping system so that their transport route can be tracked, it is advantageous to also use the transponders when such consignments are deposited into an electronic parcel deposit box facility. Within the scope of the operation of electronic parcel deposit box facilities, depositing the consignments into the individual compartments of the facility and acquiring the data belonging to each consignment by a deliverer are huge time factors. This is especially the case when various parcel shipments of different sizes and with or without COD payments are to be deposited.

### SUMMARY OF THE INVENTION

Therefore, an exemplary embodiment of the present invention may provide a lock box facility with several compartments into which objects can be deposited and subsequently picked up, whereby the time needed for depositing the objects should be reduced. Moreover, the error-free acquisition of data that is associated with the individual objects at the time of the depositing is to be improved.

The lock box facility according to an exemplary embodiment of the present invention serves for depositing objects into and retrieving objects from compartments of the lock box facility, whereby each compartment has a door that can be locked by a locking device. The locking device may be connected to a control unit that comprises an actuator that actuates the locking device via control signals. The control unit may, in turn, be connected to a data processing unit, whereby an unambiguous compartment identification is associated with each compartment. Moreover, the data processing unit can ascertain which compartments contain an object, whereby the dimensions of at least two of the compartments differ from each other and these dimensions of the compartments are stored in the data processing unit.

According to an exemplary embodiment of the present invention, the lock box facility comprises a centralized facility reading device that is connected to the data processing unit. The centralized facility reading device has a detector that is adapted to detect at least one RFID transponder located within a defined area around this reading device, and a reader that is adapted to read data from the RFID transponder. Here, the data read out from the transponder contains at least the dimensions of the object that is associated with that particular RFID transponder. The data processing unit also has a receiver and processor for the data that has been read out from the RFID transponder, configured in such a way that, on the basis of the dimensions of an object ascertained from the RFID data and, on the basis of a query about the occupation status of the compartments of the lock box facility, a free compartment can be ascertained whose dimensions are larger than the dimensions of the object. The data processing unit comprises a transmitter that is adapted to transmit the compartment identification of the ascertained free compartment to the control unit, whereby the control unit has a control signal generator that is adapted to generate a control signal to the locking device in order to open the door of the appertaining free compartment having the transmitted compartment identification.

In an exemplary embodiment of the present invention, the centralized facility reading device comprises a detector that is adapted to simultaneously detect several RFID transponders within a defined area around this facility reading device. In this case, the control unit likewise has a generator that is adapted to simultaneously generate and/or transmit several control signals to the locking device in order to open the doors of the appertaining free compartments having the transmitted compartment identifications.

In another exemplary embodiment of the present invention, the control unit comprises a generator that is adapted to consecutively generate and/or transmit several control signals to the locking device in order to open the doors of the appertaining free compartments having the transmitted compartment identifications.

In another exemplary embodiment of the present invention, a compartment reading device is arranged in at least one compartment of the lock box facility, and this compartment reading device has detector that is adapted to detect an RFID transponder located in the compartment and for reading out data from the RFID transponder. The compartment reading device has a transmitter that is adapted to transmit the data read out from the RFID transponder to the data processing unit, whereby the data processing unit comprises a storage device that is adapted to store the data for the compartment identification of the compartment in question.

An exemplary embodiment of the present invention also encompasses a method for operating a lock box facility, in which objects are deposited into compartments of the lock box facility, whereby a control unit transmits a control signal to a locking device of the compartment in order to open the door of a compartment. Moreover, the dimensions of the appertaining compartment are stored in a data processing unit so that the compartments can be identified.

According to an exemplary embodiment of the present invention, at least one RFID transponder is detected within a defined area around a facility reading device, and data is read out from the RFID transponder. The data read out from the RFID transponder contains at least the dimensions of the object on which the RFID transponder is located. The data read out from the RFID transponder is transmitted to the data processing unit. The data processing unit then ascertains which compartments of the lock box facility do not contain an object and carries out a comparison of the dimensions of the ascertained free compartments of the lock box facility with the dimensions of the object read out from the RFID transponder. On this basis, a free compartment of the lock box facility is ascertained whose dimensions are larger than the dimensions of the object.

In a subsequent step of the exemplary method, the compartment identification of the ascertained free compartment may be determined, and the compartment identification is transmitted to the control unit. The control unit receives the compartment identification and then generates a control signal. The control signal is transmitted to the locking device of the compartment along with the received compartment identification, whereby the control signal triggers the opening of the compartment door.

In an exemplary embodiment of the present invention, the centralized facility reading device simultaneously detects several RFID transponders within a defined area around this reading device and reads them out. The control unit generates several control signals and may simultaneously transmit them to the locking device in order to open the doors of the appertaining free compartments having the transmitted compartment identifications.

If the comparison of the dimensions of the object with the dimensions of the free compartments shows that there are no free compartments whose dimensions are larger than the dimensions of the object, then the data processing unit preferably generates a signal that is transmitted by the data processing unit to an operating unit of the lock box facility. The signal can be converted, for example, by the operating unit into a visual and/or acoustic message on a display device.

In another exemplary embodiment of the present invention, the control unit generates several control signals preferably consecutively and/or transmits them consecutively to the locking device in order to open the doors of the appertaining free compartments having the transmitted compartment identifications. Preferably, the sequence of the transmitted control signals depends on the dimensions of the compartments. For example, a control signal is transmitted to a compartment with smaller dimensions before a control signal is transmitted to a compartment with larger dimensions in comparison thereto.

In yet another exemplary embodiment of the present invention, a compartment reading device in at least one compartment of the lock box facility detects an RFID transponder located in the compartment and reads data out of the RFID transponder. The compartment reading device transmits the data read out from the RFID transponder to the data processing unit, whereby the data processing unit stores the data in a storage device for purposes of identifying the appertaining compartment.

An exemplary embodiment of the present invention may provide an advantage that information belonging to objects can be acquired at a lock box facility quickly and error-free. In particular, the dimensions of an object that is to be deposited into a lock box facility may be stored in an RFID transponder and may be used to ascertain free compartments into which that particular object fits. If the transponders of the objects are detected simultaneously, all of the compartments needed for depositing the objects can be opened within a very short period of time.

If a lock box facility according to an exemplary embodiment of the present invention is selected in which each compartment contains an additional reading device for reading RFID data, this may provide the advantage that the occupation status of the compartments can be retrieved at any point in time. Furthermore, the compartment reading devices can be used to systematically read out data from RFID transponders of objects that have already been associated with a compartment and deposited into it.

Another possible advantage of an exemplary embodiment of the present invention may be that business customers can deposit several consignments into one compartment, whereby this is recognized by the facility and the deliverer does not have to enter this information himself. Thus, one can likewise ensure that, if the customer picks up the object, proof of delivery can be generated for all of the consignments from one compartment.

Moreover, consignments that belong together (so-called shipping units) can be deposited together into the compartment on the basis of the automatic identification, and they can also be released together when they are picked up.

### BRIEF DESCRIPTION OF THE DRAWINGS

Additional advantages, special features and practical refinements of the invention can be gleaned from the subordinate claims and from the description below of preferred embodiments making reference to the drawings.

FIG. 1 is a schematic diagram showing a lock box facility for depositing and retrieving objects according to an exemplary embodiment of the present invention;

FIG. 2 is a block diagram showing an operating unit of a lock box facility according to an exemplary embodiment of the present invention; and

FIG. 3 is a process flow diagram showing a method for operating a lock box facility according to an exemplary embodiment of the present invention.

### DETAILED DESCRIPTION OF SPECIFIC EMBODIMENTS

An exemplary embodiment of the present invention relates to a lock box facility for depositing objects into and retrieving objects from compartments of the lock box facility, whereby each compartment has a door that can be locked by a locking means. The locking device is connected to a control unit that comprises an actuator that actuates the locking device via control signals. The control unit is, in turn, connected to a data processing unit, and an unambiguous compartment identification is associated with each compartment. The data processing unit can ascertain which compartments contain an object, whereby the dimensions of at least two of the compartments differ from each other and these dimensions of the compartments are stored in the data processing unit.

An exemplary embodiment of the present invention also relates to a method for operating such a lock box facility.

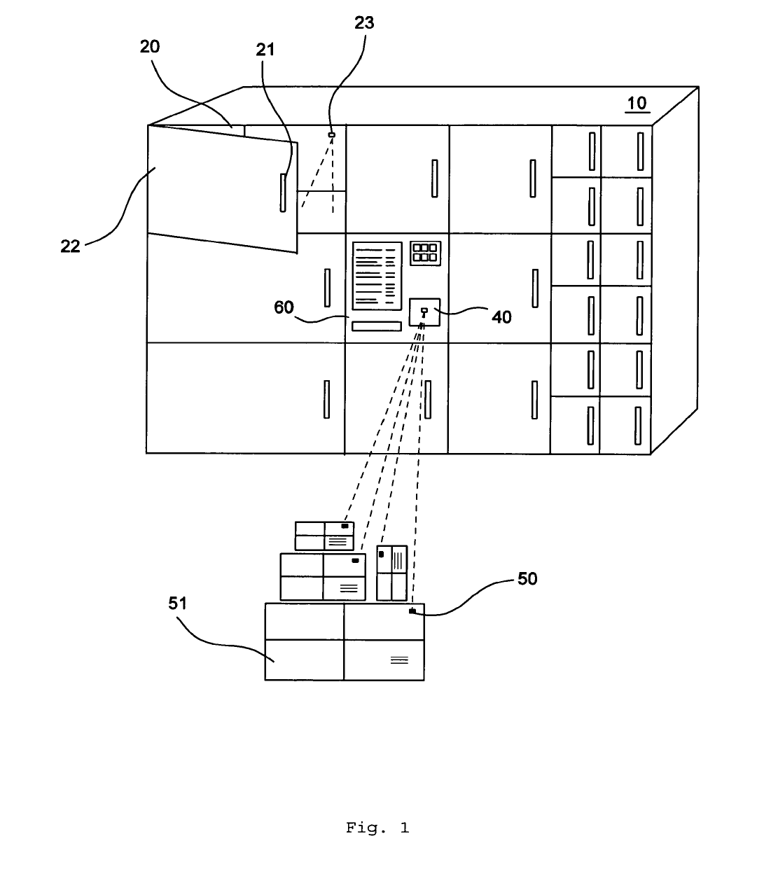

The lock box facility shown in FIG. 1 will serve as the basis on which the features of an exemplary embodiment of the present invention as well as other possible embodiments will be explained.

The lock box facility 10 comprises several compartments 20 that can each be closed with a door 22. The doors can be, for example, regular flaps that can be swiveled manually by a user. Furthermore, these can be doors with which an actuation of a mechanism—usually electronically—causes the compartment door to open and close automatically, without the user having to do this manually.

A compartment door 22 normally has a locking means 21 with which the compartment can be locked to prevent unauthorized access. In FIG. 1, these locking devices 21 are arranged on the doors for the sake of simplifying the depiction. The main part of the locking devices, however, can be located on the compartment body itself, so that a door, for example, latches only into a locking device of the compartment or is once again released by it. The locking device can have, for example, springs that automatically swing open a compartment door as soon as the locking device receives the signal from a control unit to open a compartment. The compartment door can then be pushed closed against the spring force, for example, by a user.

Preferably, the lock box facility 10 has several compartments of different sizes. In FIG. 1, three different compartment sizes are shown by way of an example, but other size variants can also be provided. The dimensions of the compartments can vary as desired, so that not only the width or height but also the depth of a compartment can be configured differently.

The lock box facility also has an operating unit 60 with which delivery and pick-up procedures are transacted at the facility. The exemplary operating unit comprises a display device such as a monitor and an information acquisition device at the lock box facility. The monitor serves for communicating with users of the lock box facility. For example, keypads, touchscreens, barcode scanners or other reading devices can be used to acquire information. Moreover, the occupation status of individual compartments and/or messages can be displayed on the monitor to a user.

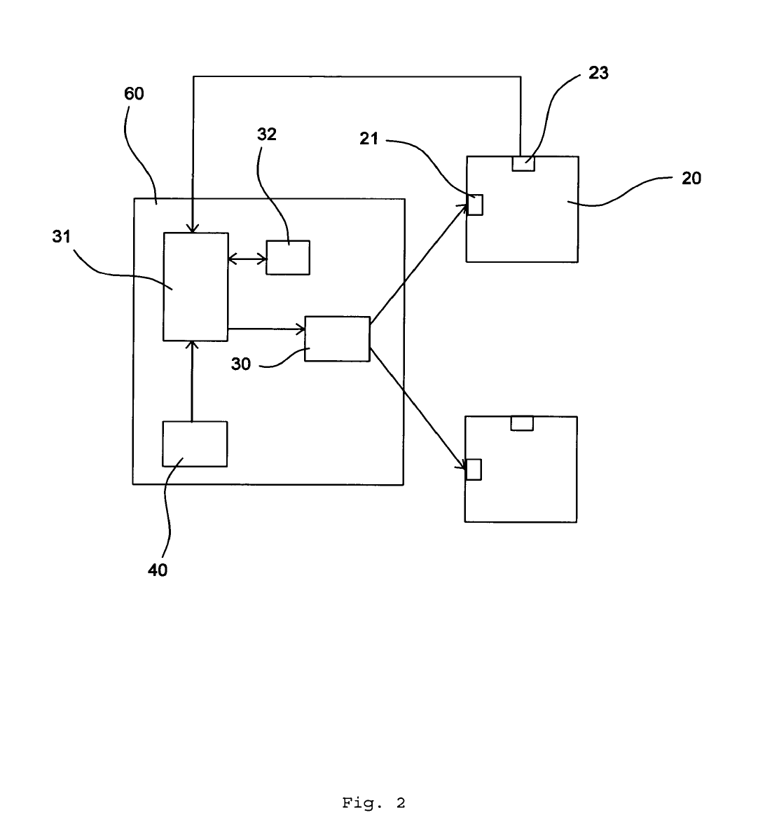

The operating unit is connected to a data processing unit 31, as is schematically shown in FIG. 2. The data processing unit processes the information received from the operating unit and also makes information available that is to be forwarded via the operating unit to a user of the lock box facility. For example, the data processing unit checks access rights of users who enter an access code at the operating unit or who insert an ID card.

A centralized facility reading device 40 is preferably arranged in the vicinity of the operating unit 60, said reading device comprising a detector that is adapted to detect and read out RFID transponders located within a defined area around the facility reading device 40. For this purpose, the facility reading device comprises at least one antenna and one circuit for transmitting and receiving data. If the lock box facility is used, for example, as a parcel deposit box facility for depositing and picking up parcels, the RFID transponders 50 are located on the parcels 51 that are delivered via the parcel deposit box facility.

Radio identification by means of RFID (Radio Frequency Identification) is a method for reading data from and storing data onto a transponder without physical or visual contact. One of the components of an RFID system is a transponder, which can also be referred to as an RFID label, chip or tag. Active as well as passive transponders can be used. Another component is a transmitting-receiving unit that is also referred to as a reading device or reader. The data is transmitted between the transponder and the reading-receiving unit by means of electromagnetic waves.

Fundamentally, a transponder has an antenna, a microchip and a memory. The memory can be a rewritable memory in which information can be repeatedly stored. A reader likewise has at least one antenna and a circuit for receiving and transmitting data. During the RFID communication, the reader generates an electromagnetic field that is received by the antenna of the transponder. In the vicinity of the electromagnetic field, an induction current is formed in the antenna coil of the transponder, and this induction current activates the microchip of the RFID transponder. Once the microchip has been activated, it receives commands and can transmit its identification number or other data requested by the reader.

The use of RFID transponders as identifiers for parcels has the advantage that various types of data can be associated with the parcel and stored in the transponder, without this having to appear on the consignment as plain text or, for example, as a barcode. The information can be read out at various stations along the transport and distribution route of a parcel, whereby data can also be deleted and/or augmented. When it comes to placing identifiers on parcels, preference may be given to the use of passive transponders without their own source of power.

The RFID transponder can be integrated into the packaging of the parcel or can be located in a label that is applied onto the consignment. A label with an RFID transponder can also be purchased and printed out at the parcel deposit box facility. The data pertaining to the registered customer is automatically incorporated as the sender data. Data can be stored in the transponder by the sender of the parcel himself or else by a transport or delivery company that delivers the parcel to a parcel deposit box facility.

For example, the sender and the recipient of a consignment can be stored in the RFID transponder. Moreover, it may be advantageous to store an identification with which the consignment can be unambiguously identified within the parcel transport and parcel distribution system. This identification creates special possibilities for tracking the parcel along the route from the sender to the recipient.

The approximate dimensions of the consignment may be stored in the RFID transponder 50. The dimensions of parcels differ greatly as a function of the type of packaging chosen by the sender. In order to associate a postage fee with the consignment, however, the dimensions can generally be classified within certain size ranges, which then serve as the basis for the postage fee. The calculation includes the dimensions as well as the weight of the consignment, so the weight can likewise be stored in the RFID transponder. The weight, however, is normally not decisive for the selection of a suitable compartment of a lock box facility.

The facility reading device 40 may be arranged in such a way that several transponders of several consignments that are held by a deliverer in the vicinity of a parcel deposit box facility 10 can be simultaneously identified and read out, preferably within the scope of bulk detection. Consequently, the facility reading device 40 does not have to be located directly on or in the operating unit 60 if such an arrangement would have drawbacks in terms of the transponder detection. The facility reading device 40 may be advantageously be positioned in such a way that the transponders can be reliably detected.

If a deliverer normally approaches a parcel deposit box facility with a hand truck that holds all of the consignments intended for the parcel deposit box facility, then the facility reading device may be advantageously positioned in such a way that all of the consignments at the height of the loading platform of the hand truck can be detected. In another exemplary embodiment of the present invention, the consignments can be placed by the deliverer onto a surface provided specially for this purpose at which the facility reading device is aimed. For example, a type of drawer or tray can be pulled out of the operating unit 60 onto which the consignments can be placed.

In another exemplary embodiment of the present invention, the deliverer approaches the parcel deposit box facility with his or her delivery vehicle and, on the basis of an RFID tag installed on or in the delivery vehicle, the parcel deposit box facility recognizes that this is a deliverer and it activates the reading device. Without the deliverer having to remove the consignments from the vehicle, the RFID reading device reads the number and size of the consignments and prepares the depositing process. After the PIN has been entered by the deliverer, the depositing process is started, that is to say, the appropriate number of compartments in the required size at the parcel deposit box facility is opened.

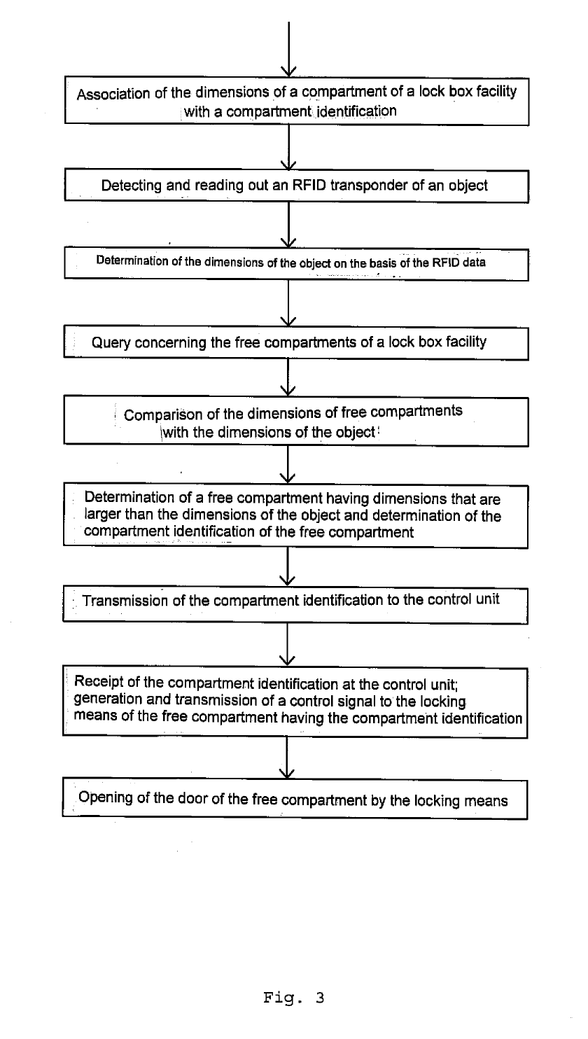

The steps of a method according to an exemplary embodiment of the present invention are shown in the flow chart in FIG. 3. Before the parcel deposit box facility is put into operation, the dimensions of the individual compartments have to be associated with the compartment identifications. In this process, advantageously, the width, height and depth of a compartment may be taken into account and stored in the data processing unit 31.

If a deliverer brings the parcels near a parcel deposit box facility, the facility reading device 40 identifies one or more RFID transponders within a defined area around the reading device and reads out the data stored in the transponders. The read-out data includes at least the dimensions of the individual parcels. A more comprehensive acquisition and processing of transponder data can include, for example, the identification of the specific transponder or of the object. The facility reading device transmits this data to a data processing unit 31, as is schematically shown in FIG. 2. The data processing unit then ascertains the free compartments of the lock box facility into which each of the individual parcels fits, on account of their dimensions.

The free compartments of the lock box facility 10 can be ascertained by the data processing unit 31 in various ways. For example, the current occupation status of all of the compartments can be stored in the data processing unit. Once a parcel is deposited into a compartment, this compartment is noted as being occupied. After the consignment has been removed again, the status of the compartment is changed accordingly and the compartment is considered as being free. The occupation status of the individual compartments can be stored in the data processing unit 31 of the parcel deposit box facility 10 or in a remotely arranged central data processing unit, from which this information can be requested.

In another exemplary embodiment of the present invention, another compartment reading device 23, consisting of at least one antenna, is located in each compartment of the parcel deposit box facility. Each antenna may be connected to a reading device. Another reading device may be located, for example, in a control cabinet of the lock box facility. A selection combinational circuit, which can also be referred to as a multiplexer, may be installed between the antennas of the compartments and the centralized reading device in the control cabinet. The circuit arrangement makes it possible to ascertain from which compartments signals are coming from transponders. The combinational circuit makes it possible to read out several compartments with one centralized reading device.

The compartment reading devices 23 can be used to actively ascertain at any time the current occupation status of the compartments of the lock box facility in that radio waves are emitted by the antenna of a compartment. In this manner, information can be read upon command, if a parcel with a corresponding transponder is present in a compartment. The transponder receives the signal and, in return, sends the information that is stored in the transponder to the antenna of the compartment and thus to the centralized reading device.

Therefore, as soon as the dimensions of several parcels that are to be deposited into a parcel deposit box facility have been ascertained by the data processing unit 31, an active query about the occupation status of the compartments can be carried out by means of the individual compartment reading devices.

Moreover, the possibility exists to ascertain the occupation status of a compartment if changes occur in the status of the compartment. This happens, for example, when a compartment is opened and closed again. When a compartment is closed, the antenna of that compartment may emit a signal and if a transponder in the compartment can be detected and read out, then the compartment may be noted as being occupied. If no transponder can be detected, the compartment is considered to be free. The occupation status can be stored in the data processing unit from which this information can be requested.

Moreover, cyclical queries about the occupation status are possible. Consequently, there are various possibilities for determining the occupation status of the compartments of a lock box facility. In any case, the occupation status can be used by the data processing unit 31 to ascertain free compartments of a size into which the parcels that are to be deposited will fit on account of their dimensions.

Each compartment may have an unambiguous compartment identification and the dimensions of the appertaining compartment are associated with the identification. The associations of the compartment identification with the dimensions are stored in the data processing unit 31. By means of a comparison of the dimensions of the parcels to the dimensions of the free compartments, the data processing unit ascertains the required compartments for the placement of the parcels. Here, an algorithm stored in the data processing unit preferably always determines the smallest possible compartment into which a consignment can be deposited. If no free compartment with suitable dimensions is available, then this is indicated on the monitor to the deliverer.

The compartment identifications of the free compartments into which parcels can be deposited are transmitted by the data processing unit 31 to a control unit 30, as is schematically shown in FIG. 2. Together with the identifications, a command to open compartments may be transmitted to the control unit. The control unit is configured in such a way that it uses control signals to actuate the locking device of the compartments and thus to activate the opening and closing of locks.

As soon as the control unit of the data processing unit has received one or more compartment identifications as well as the command to open these compartments, it generates and transmits the necessary control signals to the compartments with these compartment identifications. The control signals can be generated and transmitted either simultaneously or consecutively.

In the case of a simultaneous transmission of the control signals, all of the actuated compartments open at the same time and the deliverer can deposit all of the consignments consecutively. In the case of a consecutive transmission of the control signals to the locking device of the compartment doors, the compartments open consecutively and the deliverer can likewise deposit all of the consignments consecutively. For this purpose, the deliverer can recognize which compartments are of an adequate size, and he or she deposits the consignments on this basis. Moreover, it can be provided that specific compartments were already associated with the consignments by the data processing unit and that this association is displayed to the deliverer so that he or she can systematically deposit the consignments. For this purpose, however, it is necessary for an identification of each consignment to be displayed to the deliverer, said identification being present on the consignment.

For example, it can be provided that an unambiguous identifier that identifies the consignment for the deliverer is applied onto the transponder label. This can be a sequence of numbers or letters that can be read by the deliverer. The identifier is likewise stored in the RFID transponder of the object and is read out by the facility reading device. Once the data processing unit 31 has ascertained a free compartment of an adequate size for a consignment, the identifier is associated with the compartment and can be displayed to the deliverer.

The identifier can be shown to the deliverer, for example, on a display on the selected compartment. Moreover, the possibility exists to display a graphic representation of all compartments of the parcel deposit box facility on the monitor of the operating unit 60 and, for each compartment, to display the identifier of the parcel that fits into the appertaining compartment and that should thus be deposited there.

Moreover, with the consecutive opening of the compartments, it can also be provided that the compartments open in the order of their size so that the deliverer can also select and deposit the parcels in the order of their size. For example, the smallest compartments can be opened first so that the deliverer deposits the smallest parcels in that order. Then the compartments of the next-larger size are opened. This order of opening may be advantageous when the parcels have already been stacked by a deliverer in order to be transported to a parcel deposit box facility, since the stack is normally such that smaller parcels are stacked on top of larger packages.

In another exemplary embodiment of the present invention, the RFID transponders of several parcels are detected at the same time, but the deliverer still has to once again detect the identifications or identifiers of the individual consignments. For example, the data processing unit 31 associates the identifications of the consignments with free compartments into which the consignments fit on account of their size. However, the compartments are not opened immediately. The deliverer has to once again scan the parcels, for example, by using the RFID transponders or by using a supplementary barcode and only then does the compartment associated with the consignment open.

In another exemplary embodiment of the present invention, the facility reading device 40 only detects one RFID transponder of a parcel and then the fitting compartment for the consignment opens up for the deliverer. The data read out from the transponder can be stored directly for that compartment, and all the deliverer has to do is deposit the consignment.

In order to ensure that the only consignments to be registered as having been deposited are those that have indeed been deposited, it has proven to be advantageous for the depositing to be confirmed. This can be done by the deliverer, for example, by once again detecting the transponder of the consignment by using a compartment reading device 23 or by pressing a confirmation button.

In an exemplary embodiment of the present invention, it is possible to deposit not only objects having an RFID transponder into a lock box facility, but also consignments having different types of identifiers. If a lock box facility is used, for example, by several transport and delivery companies, the various companies can provide different types of identifiers on their consignments. In order to allow all types of consignments to be deposited, the lock box facility can be provided, for example, with a barcode scanner by means of which data about consignments can be acquired if a consignment has a barcode, but not an RFID transponder.

Additional barcode scanners can also be used so that consignments can be scanned and deposited, even if a transponder or a reading device has a technical defect.

Moreover, the RFID technology can be combined with a shipment notification in which the parcel deposit box facility was already notified of the data about the consignments to be deposited. At the parcel deposit box facility, this data is associated with the consignments having the RFID tags and the consignments are then deposited.

FIG. 3

Association of the dimensions of a compartment of a lock box facility with a compartment identification

Detecting and reading out an RFID transponder of an object

Determination of the dimensions of the object on the basis of the RFID data

Query concerning the free compartments of a lock box facility

Comparison of the dimensions of free compartments with the dimensions of the object

Determination of a free compartment having dimensions that are larger than the dimensions of the object and determination of the compartment identification of the free compartment

Transmission of the compartment identification to the control unit

Receipt of the compartment identification at the control unit; generation and transmission of a control signal to the locking means of the free compartment having the compartment identification

Opening of the door of the free compartment by the locking device

### LIST OF REFERENCE NUMERALS

10 lock box facility, parcel deposit box facility
20 compartment
21 locking means, lock
22 compartment door
23 compartment reading device
30 control unit
31 data processing unit
32 storage means, memory
40 facility reading device
50 RFID label, transponder
51 object, consignment, parcel
60 operating unit

1-14. (canceled)

15. A lock box system that is adapted to deposit objects into and retrieve objects from a plurality of compartments of the lock box system, each compartment having an unambiguous identifier and a door that can be locked by an associated locking device, the lock box system comprising:
a data processing unit that is adapted to determine which compartments contain an object, whereby dimensions of at least two of the compartments differ from each other and these dimensions of the compartments are stored in the data processing unit;
a centralized facility reading device that is connected to the data processing unit, the centralized facility reading device having a detector that is adapted to simultaneously detect a plurality of RFID transponders located within a defined area around the centralized facility reading device, the centralized facility reading device additionally comprising a data reading device that is adapted to simultaneously read out data from the plurality of RFID transponders, wherein the data read out from a particular one of the plurality of RFID transponders contains at least dimensions of an associated object;
a receiving and processing device connected to the data processing unit, the receiving and processing device being adapted to receive the data read out from the particular one of the plurality of RFID transponders, the receiving and processing device being adapted to, based on dimensions of the associated object and a query of an occupation status of the plurality of compartments, identify a free one of the plurality of compartments having dimensions sufficiently large to accommodate the associated object;
a transmitter that is adapted to transmit the identity of the free one of the plurality of compartments to the control unit; and
a control unit connected to the data processing unit, the control unit having an actuator that is adapted to actuate the locking device via control signals, the control unit being adapted to simultaneously or consecutively generate and/or transmit control signals to the locking device associated with the identified free one of the plurality of compartments to open the door of the identified free one of the plurality of compartments.

16. The lock box system recited in claim 15, comprising a compartment reading device arranged in at least one compartment of the lock box facility, the compartment reading device including:
an RFID transponder identifier located in the at least one compartment, the compartment reading device being adapted to read data from the RFID transponder; and
an RFID data transmitter that is adapted to transmit the data read from the RFID transponder to the data processing unit, the data processing unit being adapted to store the data for the compartment identification of the compartment in question.

17. A method for operating a lock box facility in which objects are deposited into compartments of the lock box facility, whereby a control unit transmits a control signal to a locking device of each compartment in order to open a door of the compartment, and in which the dimensions of the appertaining compartment are stored in a data processing unit so that the compartments can be identified, the method comprising:
detecting a plurality of RFID transponders within a defined area around a facility reading device;
reading data from at least one of the plurality of RFID transponders, the data containing at least dimensions of an object associated with the at least one of the plurality of RFID transponders;
transmitting the data read from the at least one of the plurality of RFID transponders to the data processing unit;
determining which of the compartments of the lock box facility do not contain an object;
comparing dimensions of the compartments of the lock box facility determined not to contain an object with the dimensions of the object read out from the at least one of the plurality of RFID transponders;
determining whether one of the compartments of the lock box facility determined not to contain an object has dimensions sufficiently large to contain the object that corresponds to the at least one of the plurality of RFID transponders;
identifying the one of the compartments of the lock box facility having dimensions sufficiently large to contain the object that corresponds to the at least one of the plurality of RFID transponders;
transmitting the identity of the one of the compartments of the lock box facility having dimensions sufficiently large to contain the object that corresponds to the at least one of the plurality of RFID transponders to the control unit;
generating a control signal; and
transmitting the control signal to open the locking device of the identified one of the compartments of the lock box facility having dimensions sufficiently large to contain the object that corresponds to the at least one of the plurality of RFID transponders.

18. The method recited in claim 17, comprising transmitting control signals to free compartments, whereby the order of the transmitted control signals depends on the dimensions of the compartments.

19. The method recited in claim 17, wherein a control signal is transmitted to a compartment having smaller dimensions before a control signal is transmitted to a compartment having larger dimensions in comparison thereto.

20. The method recited in claim 17, comprising:
identifying an RFID transponder located in one of the compartments of the lock box facility; and
reading data from the RFID transponder;
transmitting the data read from the RFID transponder to the data processing unit; and
storing the data in a storage device for purposes of identifying the one of the compartments.

21. The method recited in claim 17, comprising:
generating a signal if the comparison of the dimensions of the object with the dimensions of the free compartments shows that there is no free compartment whose dimensions are larger than the dimensions of the object; and
transmitting the signal to an operating unit of the lock box facility.

22. The method recited in claim 21, comprising transforming the signal into a visual and/or acoustic message representative of a physical system on a display device.

23. A lock box facility in which objects are deposited into compartments of the lock box facility, whereby a control unit transmits a control signal to a locking device of each compartment in order to open a door of the compartment, and in which the dimensions of the appertaining compartment are stored in a data processing unit so that the compartments can be identified, the lock box facility comprising:
means for detecting a plurality of RFID transponders within a defined area around a facility reading device;
means for reading data from at least one of the plurality of RFID transponders, the data containing at least dimensions of an object associated with the at least one of the plurality of RFID transponders;
means for transmitting the data read from the at least one of the plurality of RFID transponders to the data processing unit;
means for determining which of the compartments of the lock box facility do not contain an object;
means for comparing dimensions of the compartments of the lock box facility determined not to contain an object with the dimensions of the object read out from the at least one of the plurality of RFID transponders;
means for determining whether one of the compartments of the lock box facility determined not to contain an object has dimensions sufficiently large to contain the object that corresponds to the at least one of the plurality of RFID transponders;
means for identifying the one of the compartments of the lock box facility having dimensions sufficiently large to contain the object that corresponds to the at least one of the plurality of RFID transponders;
means for transmitting the identity of the one of the compartments of the lock box facility having dimensions sufficiently large to contain the object that corresponds to the at least one of the plurality of RFID transponders to the control unit;
means for generating a control signal; and
means for transmitting the control signal to open the locking device of the identified one of the compartments of the lock box facility having dimensions sufficiently large to contain the object that corresponds to the at least one of the plurality of RFID transponders.
